(19) United States
(12) Patent Application Publication
(10) Pub. No.: US 2018/0367456 A1
(43) Pub. Date: Dec. 20, 2018

(54) SYSTEM AND METHOD TO FACILITATE PACKET FORWARDING USING STATEFUL BIT INDEX EXPLICIT REPLICATION (BIER) IN A NETWORKING ENVIRONMENT

(71) Applicant: CISCO TECHNOLOGY, INC., San Jose, CA (US)

(72) Inventors: Ijsbrand Wijnands, Leuven (BE); Neale D.R. Ranns, Basingstoke (GB); John H.W. Bettink, San Jose, CA (US); Alessandro Fulli, Los Gatos, CA (US)

(73) Assignee: CISCO TECHNOLOGY, INC., San Jose, CA (US)

(21) Appl. No.: 15/628,452

(22) Filed: Jun. 20, 2017

(51) Int. Cl. H04L 12/741; H04L 12/707; H04L 12/761

(52) U.S. Cl. CPC H04L 45/745; H04L 45/24; H04L 12/1854; H04L 45/54; H04L 45/16

(57) ABSTRACT

A method is provided in one example embodiment and may include receiving a packet at a node, wherein the node comprises one or more first data structures comprising Bit Index Explicit Replication (BIER) BitMask information for one or more neighboring forwarders and a second data structure comprising multicast forwarding information; identifying a BIER BitString contained in the packet, wherein the BIER BitString is identified within an Internet Protocol (IP) header or a label included with the packet; determining multicast forwarding information for the packet based on the BIER BitString; and forwarding the packet toward a plurality of destination nodes based on the multicast forwarding information.

### TECHNICAL FIELD

This disclosure relates in general to the field of computer networking, and more particularly, to a system and method to facilitate packet forwarding using stateful Bit Index Explicit Replication (BIER) in a networking environment.

### BACKGROUND

Networking architectures have grown increasingly complex in communication environments. Bit Index Explicit Replication (BIER) architectures have been introduced that enable packet forwarding and replication using BIER protocol constructs as defined by Internet Engineering Task Force (IETF) standards. However, some datacenter switches do not have programmable forwarding engines and therefore cannot support newer networking architectures such as BIER. Accordingly, deployment of BIER architectures presents a significant challenge to network developers.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system in which packet forwarding using stateful Bit Index Explicit Replication (BIER) can be implemented for a networking environment according to at least one embodiment of the present disclosure;

FIG. 2 is a simplified block diagram illustrating example operations and interactions that can be performed to facilitate packet forwarding in accordance with one potential embodiment of the communication system;

FIGS. 3A-3B are simplified schematic diagrams illustrating example details that can be associated with example packets that can support stateful BIER forwarding in accordance with at least one embodiment;

FIG. 4 is a simplified flow diagram illustrating example operations that can be associated with stateful BIER packet forwarding in accordance with at least one embodiment;

FIG. 5 is a simplified flow diagram illustrating other example operations that can be associated with stateful BIER packet forwarding in accordance with at least one embodiment; and

FIG. 6 is a simplified block diagram illustrating example details that can be associated with a node that can be configured to operate in the communication system in accordance with at least one embodiment.

### DETAILED DESCRIPTION OF EXAMPLE EMBODIMENTS

### Overview

A method is provided in one example embodiment and may include receiving a packet at a node, wherein the node comprises one or more first data structures comprising Bit Index Explicit Replication (BIER) BitMask information for one or more neighboring forwarders and a second data structure comprising multicast forwarding information; identifying a BIER BitString contained in the packet, wherein the BIER BitString is identified within an Internet Protocol (IP) header or a label included with the packet; determining multicast forwarding information for the packet based on the BIER BitString; and forwarding the packet toward a plurality of destination nodes based on the multicast forwarding information.

The BIER BitMask information for each of the one or first data structures can identify a respective BitMask for each of a respective next-hop neighbor node for a particular BIER subdomain and a particular Set Identifier. The multicast forwarding information for the second data structure can identify one or more BIER BitStrings and, for each of a particular BIER BitString, the second data structure can further identify one or more output interfaces associated with the particular BIER BitString upon which received packets are to be forwarded and a BIER BitString that is to be included with each packet forwarded across the output interfaces.

The forwarding can include updating the IP header or the label included with the packet. In some cases, the updating can include one of: removing the IP header or the label included with the packet and including a new IP header or a new label with the packet, wherein the new IP header or the new label includes a new BIER BitString; or overwriting the IP header or the label to include a new BIER BitString.

In some cases, the method can include replicating the packet based on a determination that the multicast forwarding information identifies diverging forwarding paths for the packet; updating the IP header or the label included with each replicated packet based on the multicast forwarding information; and forwarding each replicated packet to a next-hop neighbor node as identified in the multicast forwarding information.

In some cases the determining and the forwarding can include determining whether the BIER BitString is identified in the second data structure; and forwarding the packet based on the multicast forwarding information contained in the second data structure based on a determination that the BIER BitString is identified in the second data structure. In some instances, the method can further include identifying BIER BitMask information associated with the BIER BitString using a particular first data structure based on a determination that the BIER BitString is not identified in the second data structure; and updating the second data structure with the multicast forwarding information based on the BIER BitMask information identified in the particular first data structure.

### Example Embodiments

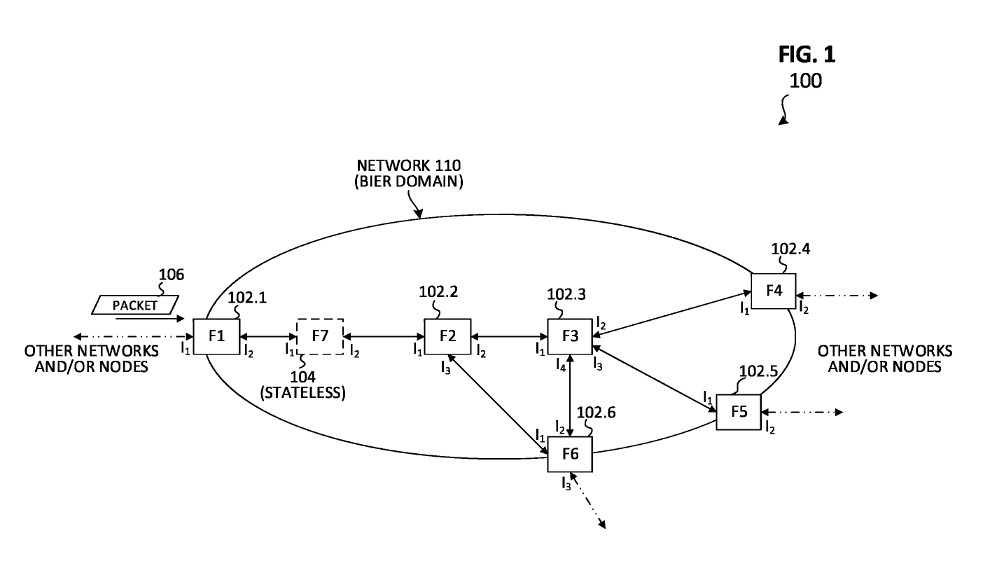

Referring to FIG. 1, FIG. 1 is a simplified block diagram illustrating example details associated with a communication system 100 in which packet forwarding using stateful Bit Index Explicit Replication (BIER) can be implemented for a networking environment according to one embodiment of the present disclosure. FIG. 1 includes a number of stateful BIER enabled forwarder (F1-F6) 102.1-102.6 within a network 110. Forwarder discussed herein can be referenced herein using ‘F’ labels (e.g., F1-F6). In some embodiments, stateless BIER-capable forwarders such as stateless BIER-capable forwarder F7 104 can be provisioned within network 110. Although only six stateful BIER enabled forwarders 102.1-102.6 are illustrated in communication system 100, it should be understood that any number of stateful BIER enabled forwarders and/or traditional BIER enabled forwarders can be deployed in communication system 100 depending on needs and/or implementations. As referred to herein in this Specification, a ‘router’, a ‘forwarder’, and/or a ‘switch’ can be referred to interchangeably as a ‘node’. For various discussions herein, stateful BIER enabled forwarders (e.g., F1-F6 102.1-102.6) can be referred to more generally as forwarders or nodes.

As referred to herein in this Specification, nodes that natively support BIER forwarding operations are referred to as ‘BIER-capable’ nodes and nodes that do not natively support BIER forwarding processes but which can be provisioned to perform BIER-like operations using various BIER constructs are referred to herein as ‘BIER enabled’ nodes.

Generally, communication system 100 can include one or more networks, such as network 110, which represent a series of points or nodes of interconnected communication paths for receiving and transmitting messages (e.g., packets) that propagate through the one or more networks. These nodes can offer communicative interfaces between nodes. Each node can be configured with a number of interfaces through which communications (e.g., packets) can be exchanged with one or more other network(s) and/or node(s).

In general, the term ‘interface’ can be associated with physical and/or logical protocol and application based interfaces as well as hardware network interfaces. Interfaces can be configured for nodes in a network to enable packet flows to enter and exit the nodes. Protocol and application based interfaces can include, but not be limited to, Internet Protocol (IP), User Datagram Protocol (UDP) UDP, Transmission Control Protocol (TCP), Multiprotocol Label Switching (MPLS), Segment Routing (SR), tunneling protocols such as Generic Routing Encapsulation (GRE), Point-to-Point Tunneling Protocol (PPTP), Layer Two Tunneling Protocol L2TP), or the like as may be defined by the Institute of Electrical and Electronics Engineers (IEEE), the Internet Engineering Task Force (IETF), the European Telecommunications Standards Institute (ETSI), the Wi-Fi Alliance®, equipment manufacturers, or the like. Hardware network interfaces can include, but not be limited to, Ethernet, Fibre Channel, IEEE Standard 802.11 (e.g., Wi-Fi), IEEE Standard 802.16 (e.g., WiMAX), millimeter wave (mm.wave), or the like as may be defined by the IEEE, the IETF, ETSI, the Wi-Fi Alliance®, equipment manufacturers, or the like.

Interfaces provisioned for each forwarder illustrated for the embodiment of FIG. 1 are referenced herein using ‘I’ labels (e.g., I₁, I₂, I₃, etc.). For the embodiment of FIG. 1, forwarder F1 102.1 can be provisioned with a first interface I₁ that can facilitate the exchange of communications with other network(s) and/or node(s) external to network 110 and can be provisioned with a second interface I₂ that can facilitate the exchange of communications with an adjacent forwarder (e.g., forwarder F7 104 or forwarder F2 102.2, depending on implementation). Forwarder F2 102.2 can be provisioned with a first interface I₁ that can facilitate the exchange of communications with an adjacent forwarder (e.g., forwarder F7 104 or forwarder F1 102.1, depending on implementation), can be provisioned with a second interface I₂ that can facilitate the exchange of communications with forwarder F3 102.3, and can be provisioned with a third interface I₃ that can facilitate the exchange of communications with forwarder F6 102.6. Forwarder F3 can be provisioned with a first interface I₁ that can facilitate the exchange of communications with forwarder F2 102.2, can be provisioned with a second interface I₂ that can facilitate the exchange of communications with forwarder F4 102.4, can be provisioned with a third interface I₃ that can facilitate the exchange of communications with forwarder F5 102.5, and can be provisioned with a fourth interface I₄ that can facilitate the exchange of communications with forwarder F6 102.6. Forwarder F4 102.4 can be provisioned with a first interface I₁ that can facilitate the exchange of communications with forwarder F3 102.3 and can be provisioned with a second interface I₂ that can facilitate the exchange of communications with one or more other network(s) and/or node(s) external to network 110. Forwarder F5 102.5 can be provisioned with a first interface I₁ that can facilitate the exchange of communications with forwarder F3 102.3 and can be provisioned with a second interface I₂ that can facilitate the exchange of communications with one or more other network(s) and/or node(s) external to network 110. Forwarder F6 102.6 can be provisioned with a first interface I₁ that can facilitate the exchange of communications with forwarder F2 102.2, can be provisioned with a second interface I₂ that can facilitate the exchange of communications with forwarder F3 102.3, and can be provisioned with a second interface I₃ that can facilitate the exchange of communications with one or more other network(s) and/or node(s) external to network 110. In at least one embodiment, stateless BIER-capable forwarder F7 104 can be provisioned with first and second interfaces I₁-I₂ to facilitate communications with adjacent forwarders.

It should be understood that the number of interfaces and interconnections illustrated for the embodiment of FIG. 1 are provided for illustrative purposes only and are not meant to limit the broad scope of the present disclosure. Nodes (e.g., stateful BIER enabled forwarders F1-F6 102.1-102.6, etc.) within network 110 can be provisioned with any number of interfaces depending on needs and/or implementations.

As referred to herein in this Specification, the term ‘plane’ can refer to a separation of traffic that can traverse a network. Three planes can typically be found in communication networks including: a data-plane, a control-plane and a management-plane. The data-plane typically carries or forwards user traffic, while the control-plane typically carries signaling traffic used to provide routing information for user traffic and the management-plane, a subset of the control-plane, typically carries administrative traffic. In some instances, control-plane information (e.g., source and destination addresses, source and destination ports, version information, flags, etc.) can be carried in header(s) and/or trailer(s) of data-plane packets. As referred to herein in this Specification, the terms ‘user-plane’, ‘data-plane’ and ‘user data-plane’ can be used interchangeably. Nodes in communication system 100 can support various control-plane and data-plane operations in accordance with various embodiments described herein.

Communications in a network environment are referred to herein as ‘messages’, ‘messaging’, ‘signaling’, and/or variations thereof which may be inclusive of packets. Generally, signaling is referred to in reference to control-plane or management-plane packets while messaging can be referred to in reference to control-plane, management-plane or data-plane packets exchanged for communications at the application level.

A packet is a formatted unit of data and can contain both control information (e.g., source and destination address, etc.) and data, which is also known as payload (e.g., a trigger payload). In some embodiments, control information can be included in headers and trailers for packets. Messages can be sent and received according to any suitable communication protocols. Suitable communication protocols can include a multi-layered scheme such as the Open Systems Interconnection (OSI) Model, or any derivations or variants thereof.

The terms ‘data’, ‘information’ and ‘parameters’ as used herein can refer to any type of binary, numeric, voice, video, textual or script data or information or any type of source or object code, or any other suitable data or information in any appropriate format that can be communicated from one point to another in electronic devices and/or networks. Additionally, messages, requests, responses, replies, queries, etc. are forms of network traffic and, therefore, may comprise one or more packets.

As referred to herein in this Specification, a ‘flow’, ‘multicast flow’, or ‘IP flow’ can refer to a sequence of packets that can be identified using identification information that accompanies each packet of the flow. In various embodiments, identification information can include 5-tuple information carried in one or more packet headers such as source address, destination address, source port, destination port, and protocol type; BIER information, multicast information, combinations thereof, or any other information that may be carried in one or more headers and/or labels included with packets of a given flow.

For purposes of illustrating certain example techniques of packet forwarding embodiments in communication system 100, it is important to understand typical communications that can traverse BIER architectures. The following foundational information may be viewed as a basis from which the present disclosure may be properly explained. Such information is offered earnestly and for teaching purposes only and, therefore, should not be construed in a way to limit the broad applications and teachings of the present disclosure.

BIER is an innovative technology that continues to gain momentum in delivering content, which can include but not be limited to, IP Television (IPTV) content, financial information, etc. in various types of networks (e.g., service provider networks, enterprise networks, IPv6 low power wireless personal area networks (6LoWPAN), etc.) In a typical BIER deployment, BIER control-plane protocols can be used within a ‘BIER domain’ such that forwarders in the BIER domain can perform BIER forwarding operations using BIER constructs, such as, for example, a BIER header, data structures such as a Bit Index Routing Table (BIRT) and a Bit Index Forwarding Table (BIFT), etc. as defined in Internet Engineering Task Force (IETF) ‘draft-ietf-bier-architecture-05’ or the like as may be defined by the IETF.

Each traditional BIER-capable forwarder in a BIER domain, often referred to as Bit-Forwarding Routers (BFRs), can be assigned a BFR-Identifier (BFR-ID) by a network operator, such that each BFR-ID can be associated with a unique positive integer identifying each forwarder in the BIER domain. In some cases, a BIER domain can be divided into BIER sub-domains in which each forwarder in each BIER sub-domain (SD) is assigned a unique BFR-ID. In still some cases, a Set Identifier (SI) can be used to identify a particular set of BFRs in a particular BIER SD to which packets can be delivered.

In general, traditional BIER forwarding operations can involve including a BIER header with packets traversing a BIER network. Among other information, the BIER header can include a BIER BitString. Each bit position in the BIER BitString can be associated with a BFR-ID identifying destination node(s) to which packets are to be delivered. Given the BitString bit position dependency BFR-IDs can range from 1, 2, 4, 8, etc. A BFR-ID of ‘3’ (e.g., binary[011]) would not be valid BFR-ID but rather would identify BFR-ID 1 and BFR-ID 2 for a BIER BitString.

When a BIER-capable forwarder in a BIER deployment receives a packet including a BIER header, the forwarder performs a forwarding lookup using A BIFT, which can include one or more Forwarding BitMask(s) that can be used to determine next-hop neighbor(s) to which packet(s) are to be forwarded in order to reach certain destinations BFRs (e.g., BFERs). If replication is needed for diverging paths, a forwarder can replicate the packet, reset bit(s) in the BIER BitString based on the destinations to which it is to forward the replicated packets and forward the packets toward the destinations. A BIER header can include other information such as, for example, a BIFT identifier, a BitString Length (BSL) field, a Time To Live (TTL) field, a Traffic Class (TC) field, and/or other various fields and/or information as may be prescribed by IETF standards. The BSL field identifies the length of a BIER BitString carried in a BIER packet. A BIER-capable forwarder can be provisioned with a different BIFT for each combination of {SD, SI, BSL} for packets that may be forwarded by the forwarder.

A typical BIER network can include any combination of: Bit-Forwarding Ingress Routers (BFIRs) that can receive packets from node(s) outside the BIER domain and forward the packets to other node(s) within the domain; Bit-Forwarding Egress Routers (BFERs) which can receive packets from within the BIER domain and forward the packets to node(s) outside the BIER domain; and transit routers, which can forward packets to neighboring routers within the BIER domain. In some cases, depending on the direction of packets, a BIER-capable router/forwarder can be both a BFIR and a BFER. In a typical BIER network, BFIRs receive packets, determine BFER destination(s) to which the packets are to be delivered, set bits in the BIER BitString that identify these BFER(s) and forward the packets toward the BFER(s).

Nodes that natively support BIER can forward BIER packets by parsing the BitString and make forwarding decisions on the fly by doing the BIER specific lookup in the BIFT. A BIFT can represent the maximum set of replications that a node might make for a given BIER packet. Based on which bits are set, traditional BIER forwarding logic will only choose the set of interfaces relevant to the encoded BitString in determining forwarding and replication decisions. Traditional BIER deployments offer simplicity for performing forwarding and replication decisions for multicast flows, however, network providers that seek to implement BIER architectures typically desire to deploy such architectures in datacenters that include routers, forwarders, switches, etc. that do not have micro-programmable forwarding engines (e.g., Application Specific Integrated Circuit (ASIC), field programmable gate array (FPGA), or the like) that can be re-programmed to handle BIER forwarding processes; therefore, the forwarding engines are limited to what the forwarding chip (e.g., ASIC, FPGA, etc.) can support. For this reason supporting the BIER forwarding logic on such platforms presents a significant challenge to network developers.

According to embodiments described herein, communication system 100 can overcome these shortcomings by providing a system and method in which stateful BIER enabled forwarders F1-F6 102.1-102.6 can be provisioned for network 110 and can perform BIER-like forwarding operations that combine BIER forwarding features with existing forwarding features that may be ‘hard-coded’ or otherwise not capable of being modified for the forwarders in the network. In particular, in at least one embodiment, the system and method provide by communication system 100 provides for the ability to create flow states for stateful BIER enabled forwarders F1-F6 102.1-102.6.

Stateful BIER enabled forwarders F1-F6 102.1-102.6 can be provisioned with one or more BIFTs (e.g., for different sub-domains) that can be provisioned with BitMask information identifying neighbor forwarders to which packets are to be forwarded to reach certain destination forwarders, also referred to herein as ‘receivers’. Stateful BIER enabled forwarders F1-F6 102.1-102.6 can also be provisioned with another data structure, referred to herein as a Multicast Forwarding Information Base (MFIB). For a given stateful BIER enabled forwarder, an MFIB can be populated with multicast forwarding information that includes: 1) one or more BIER BitString(s) that have been included in packets received by the forwarder, in which each BIER BitString identifies unique sets of destination nodes (e.g., BFERs) that are to receive packets for one or more multicast flow(s); 2) output interface information such that each received BIER BitString can be associated with one or more output interfaces upon which packets are to be forwarded to next-hop neighbors in order to reach certain destination BFERs; and 3) BIER address information that identifies new BIER BitStrings that are to be included with the outgoing packets prior to forwarding packets to next-hop neighbors. As referred to herein in this Specification, a ‘set’ of destination nodes can also be referred to as a ‘group’ of destination nodes.

Output interface information associated with a given BIER BitString for a given multicast forwarding state can include an Output-List, referred to herein as ‘O-List’, that can be used by a given stateful BIER enabled forwarder to determine when packet replication may be needed for forwarding packets to certain destinations. In at least one embodiment, an output interface associated with neighboring forwarder(s) to which packets can be forwarded by a given BIER enabled forwarder, stateful or stateless, can be provisioned and stored for each forwarder, which can enable each forwarder to determine an O-List for a BIER BitString contained in a BIER packet.

Thus, the multicast forwarding state for a given multicast flow can identify multicast forwarding information that stateful BIER enabled forwarders F1-F6 102.1-102.6 can use to forward packets toward destination BFERs using existing forwarding logic provisioned for each forwarder. Because multicast forwarding information associated with multicast forwarding states maintained in a MFIB for a stateful BIER enabled forwarder is based on BitMask information contained in a BIFT provisioned for a given stateful BIER enabled forwarder, forwarding decisions are based on BIER control-plane processing, while the actual forwarding operations can be carried out by an existing forwarding engine provisioned for the forwarder. Thus, the system and method provided by communication system 100 provides for the ability to combine BIER-like forwarding features with existing non-BIER forwarding features for existing network elements that may be present in data centers to enable network administrators to deploy BIER architectures without needing to replace existing data center network elements.

As referred to herein, the terms ‘stateful’ and ‘stateless’ are used to identify whether a forwarder maintains multicast forwarding information for one or more multicast forwarding states that can be created by a forwarder through population of the MFIB. While traditional BIER-capable forwarders maintain BIFTs, the BIFTs are not associated with particular multicast forwarding states but rather bit positions set within BIER BitStrings and BitMasks. Thus, traditional BIER-capable forwarders (e.g., stateless BIER-capable forwarder F7 104) do not maintain multicast forwarding states and are considered stateless in accordance with the teachings of the present disclosure.

For the system and method provided by communication system 100, a multicast forwarding state created for a MFIB can be associated with any multicast flow that may involve a same set of destination forwarders. Thus, the amount of state created for any stateful BIER enabled ICN forwarder is related to the number of unique destination forwarder combinations (e.g., different bit position combinations) that may be identified for multicast flows handled by a forwarder.

For embodiments discussed herein, network 110 can represent a BIER domain for which any of forwarder F1 102.1, forwarder F4 102.4, forwarder F5 102.5, and/or forwarder F6 102.6, which can be deployed at borders of the BIER domain, can be considered a BFIR and/or a BFER depending on the flow of packets into and out of the BIER domain. Consider an operational example in which a packet 106 enters the BIER domain (e.g., network 110) via forwarder F1 102.1, which would represent a BFIR for the packet 106, and that each of forwarder F4 102.4, forwarder F5 102.5, and forwarder F6 102.6 have expressed an interest within the BIER domain to receive packets of a type associated with packet 106 (e.g., having a particular combination of source/destination address, source/destination port, protocol type, and/or any other packet information that can be used to identify packets). In various embodiments, a forwarder can express an interest to receive packets of a certain type using Border Gateway Protocol advertisements, as defined in IETF Request For Comments (RFC) 4271, through static configurations of the forwarders at the borders of a domain, combinations thereof, or the like.

Stateful BIER enabled forwarders F1-F6 102.1-102.6 can create multicast forwarding states that can be populated within their MFIB based on BIER BitStrings included in received packets. In accordance with various embodiments of communication system 100, one or more fields of packets encapsulated using different types of encapsulation such as, for example, Internet Protocol (IP) version 4 (IPv4), IP version 6 (IPv6), Multiprotocol Label Switching (MPLS) protocol, and/or any other protocol can be enhanced to carry a BIER prefix, which can identify a particular set of destination forwarders (e.g., using a combination of SD, SI, and BSL) to which a packet may be forwarded, and a ‘BIER address’, which can be a BIER BitString that identifies the particular destination forwarders to which a particular packet is to be forwarded. For embodiments of communication system, BitString Lengths can include, but not be limited to, 64-4096 bits.

Thus, the multicast forwarding states created for stateful BIER enabled forwarders F1-F6 102.1-102.6 can be based on the specific encapsulation type (e.g., IPv4, IPv6, MPLS, etc.) for packets handled by the forwarders. For example, in at least one embodiment, the 128-bit destination address for IPv6 packets can be enhanced to carry a BIER prefix, which might range from 28-64 bits in length, and a BIER BitString, which might range from 64-100 bits in length, that can be carried in packets as a ‘BIER IPv6 address’. In such an embodiment, each possible destination BFER for a network (e.g., any combination of forwarders F1, F4, F5, and F6) can be assigned a ‘BIER IPv6 address’ that corresponds a BFR-ID assigned to each forwarder. In the context of such an embodiment, a ‘BIER IPv6 address’ is not a traditional 128-bit IPv6 address, but rather a BFR-ID (e.g., bit position) assigned to each possible destination BFER for each of a possible combination of {SD, SI, BSL} for a given BIER domain. For example, in an IPv6 embodiment, forwarder F1 102.1 could be assigned a BIER IPv6 address of decimal 1 (e.g., BitString=[000001]), forwarder F4 102.4 could be assigned a BIER IPv6 address of decimal 8 (e.g., BitString=[001000]), forwarder F5 102.5 could be assigned a BIER IPv6 address of decimal 16 (e.g., BitString=[010000]), and forwarder F6 102.6 could be assigned a BIER IPv6 address of decimal 32 (e.g., BitString=[100000]). Other stateful BIER enabled or stateless BIER-capable forwarders within the BIER domain could also be assigned a BIER (IPv6) address (e.g., a BFR-ID) as discussed above in order to populate BIFTs for each stateful BIER enabled and stateless BIER-capable forwarder in the BIER domain.

In various embodiments, BIER addresses, such as, for example, BIER IPv4 addresses and/or BIER IPv6 addresses can be assigned to BIER enabled and/or BIER-capable forwarders in a similar manner as discussed above for a given BIER domain for use with other protocols such as MPLS or the like. For example, for embodiments in which packets contain MPLS labels, In some embodiments, other fields of packets (e.g., source address, source/destination port, etc.) can also be enhanced to carry BIER prefix information, BIER BitString information (e.g., BIER address), and/or any other BIER information that may be used in making BIER forwarding decisions by stateful BIER enabled forwarders for a BIER domain.

Regardless of protocol type, a multicast forwarding state created for an MFIB for a given stateful BIER enabled forwarder can be based on the BIER BitString included with a packet received by the forwarder. Each unique combination of bits in a BIER BitString for a packet can be used to create a unique state for the MFIB for the forwarder. As discussed for the examples above, for IPv6 packets, the maximum BIER BitString length for a destination address can be 128 bits and for MPLS the maximum label size can be a combination of the top label (e.g., containing SD, SI, and BSL) and a given BitString length (64, 128, 256, etc.) configured for the label.

It is not expected that 128 or more bits worth of unique multicast forwarding state combinations would be created for an MFIB, as this may limit scalability. Even under an assumption that each multicast flow handled within a given network (e.g., network 110) might have a unique set of destinations; the worst case of multicast forwarding state that might be created for an MFIB would not be more than the number of multicast flows handled within the network. In many cases, especially in financial and IP Television (IPTV) deployments, multicast flows can share the same set of destinations. So it is very likely different multicast flows will hit against the same multicast forwarding state contained in an MFIB since the BIER BitString could be the same for different multicast flows.

Thus, the system and method provided by communication system 100 can provide advantages for embodiments in which multiple multicast flows share a same multicast forwarding state, compared to traditional multicast forwarding that might be based on group destination address information (typically expressed as ‘(*,G)’) or source address information and group destination address information (typically expressed as ‘(S,G)’) multicast forwarding techniques where every multicast flow can have its own set of forwarding and/or replication rules. In contrast, the system and method provided by communication system 100 provides aggregation on the basis of a same set of destinations that may be present for multiple different multicast flows.

During operation, when an stateful BIER enabled forwarder within a BIER domain receives a packet from outside the domain, the forwarder (e.g., which could be considered a BFIR) can identify the packet as belonging to a particular multicast flow (e.g., based on header, label and/or any other identifying information included with the packet), can determine a set of destination forwarder(s) (e.g., which would be considered BFER(s)) to which the packet is to be forwarded by performing a lookup on its BIFT, can replicate the packet, if needed, can update its MFIB, if needed, and can update a header or label for the packet(s) to include a BIER prefix (e.g., SD, SI, and BSL) associated with the set of forwarders and a BIER BitString identifying the destination forwarders.

Within the network, when a stateful BIER enabled forwarder receives a BIER packet, it can perform a lookup on its MFIB using the BIER BitString included with the packet is identified in the MFIB to determine whether a multicast forwarding state has been created and stored in the MFIB for the BIER BitString. If no state exists for the BIER BitString in its MFIB, the packet can be ‘punted’ or otherwise redirected from the fast forwarding path, which can perform forwarding via hardware or other data-plane forwarding logic, to the BIER control-plane to perform BIER specific processing (e.g., slow path forwarding) according to BIER forwarding logic provisioned for the stateful BIER enabled forwarder. In at least one embodiment, the BIER forwarding logic can include instructions that, when executed (e.g., by a hardware processor or the like), cause the forwarder to perform a lookup on a BIFT identified by the combination of (SD, SI, and BSL) included in the BIER prefix for the packet based on a determination that no state associated with the BitString is identified in the MFIB.

Based on the BIFT lookup using the BIER BitString, the forwarder can determine, via the BIER forwarding logic, one or more BIER BitMask(s) associated with the destination forwarders identified in the BIER BitString and one or more neighboring forwarder(s) to which the packet is to be forwarded in order to reach the destination forwarders. In at least one embodiment, the determining can include matching bit(s) set in the BIER BitString to BIER BitMask(s) identified in the BIFT and determining neighboring forwarders associated with each identified BIER BitMask.

Based on an output interface associated with each identified neighboring forwarder determined via the BIFT lookup, the forwarder via the BIER forwarding logic can generate an O-List identifying each neighboring forwarder to which the packet is to be forwarded, and can create a multicast forwarding state for the MFIB such that the state identifies the BIER BitString that was included in the BIER packet, the generated O-List, and output BIER information that identifies new BIER BitString(s) (e.g., BIER address(es)) that are to be included in (potentially multiple replicated) outgoing packet(s) that are to be forwarded to the neighboring forwarder(s) for the multicast flow. The new BIER BitString for each outgoing packet for each corresponding neighbor identified in the O-List will be set to the BIER BitMask as identified from the BIFT lookup for each corresponding neighbor.

Upon creating the multicast forwarding state, the forwarder can update the BIER BitString for each outgoing packet(s) and forward each packet(s) to an associated neighboring forwarder using existing non-BIER forwarding logic provisioned for the forwarder. Thus, a stateful BIER enabled forwarder can create a multicast forwarding state based on punting packets to the BIER control-plane. As soon as a multicast forwarding state is created for a given stateful BIER enabled forwarder, any subsequently received packet containing a same BIER BitString, for any multicast flow that may be handled by the forwarder, will be a hit (e.g., successful) upon performing the MFIB lookup and the packet can be replicated in the fast path (e.g., using data-plane forwarding hardware and/or logic). Thus, a stateful BIER enabled forwarder can perform operations similar to normal IPv6 multicast replication or an MPLS Point-to-Multipoint (P2MP) replication once a multicast forwarding state is created for multicast flow(s) that may be handled by the forwarder.

By creating the multicast forwarding state, a stateful BIER enabled forwarder can replicate packets without performing a BIER specific forwarding lookup for each packet received for a given multicast forwarding state. In addition, a stateful BIER enabled forwarder can update the BIER BitString for each replicated packet having only bit positions set that are on the shortest path to each of a given destination forwarder. This is needed to avoid packet duplication downstream. One benefit of stateful BIER forwarding is that header or label rewrites can be calculated or determined in advance when a given multicast forwarding state is programmed into the MFIB for a given forwarder. For each replicated packet, a new IPv6 header, MPLS label, etc. that includes a new BIER BitString can be pushed onto the packet. In various embodiments, a stateful BIER enabled forwarder can update a BIER BitString for a packet by removing a current header or label for the packet and adding a new header including the new BIER BitString or by re-writing the header or label for the packet with information that includes the new BIER BitString. A BIER prefix included in a BIER packet received by a forwarder can remain unchanged for outgoing packets. Removing a header or label from a packet is sometimes referred to as ‘decapping’ or variations thereof and adding a header or label to a packet is sometimes referred to as ‘enapping’ or variations thereof.

Any stateless BIER-capable forwarder(s) (e.g., stateless BIER-capable forwarder F7 104) that may receive a BIER packet from a stateful BIER enabled forwarder can be configured to parse the BIER prefix and BIER BitString from one or more header(s) or label(s) for the packet and to update the BIER BitString for replicated packets to perform BIER forwarding operations. Thus, the system and method provided by communication system 100 can provide for the ability create deployments in which traditional BIER-capable forwarders can be intermixed with stateful BIER enabled forwarders.

As noted previously, the system and method provided by communication system 100 provides aggregation on the basis of a same set of destinations that may be present for multiple different multicast flows. Thus, tree building aggregation processes for stateful BIER processes can behave differently from traditional tree building as is typically found in protocols such as Protocol Independent Multicast (PIM), multicast Label Distribution Protocol (mLDP), Resource Reservation Protocol-Traffic Engineered (RSVP-TE), or other protocols. For these protocols there is a Tree per flow or per virtual routing and forwarding (VRF) instance and multicast flows are aggregated independent of a receiver set to which multicast packets are to be forwarded.

In contrast, for embodiments described herein associated with stateful BIER operations, the amount of state that may be created for any stateful BIER enabled forwarder is related to the number of unique combinations of receiver sets to which multicast packets are to be forwarded. Thus, embodiments of communication system can provide advantages over protocols such as PIM, mLDP, RSVP-TE, or the like for deployments in which receiver sets are likely to be homogenous among many multicast flows.

One potential drawback to the system and method provided by communication system 100 might be that creating state based on unique combinations receiver sets can cause a new state to be created for each new receiver that is added to a given multicast flow. By adding new receiver to a particular multicast flow, newly received packets for the flow will be punted to the BIER control-plane, which could cause packet reordering for existing receivers. Thus, the system and method provided by communication system 100 may not be suitable for environments in which there can be a high amount dynamic joining/leaving of receivers to multicast flows. In at least one embodiment, however, packet reordering issues can be overcome by sending an Operation, Administration, and Maintenance (OAM) ping packet to each receiver of a receiver set to which a new receiver has been added before creating a new multicast forwarding state for the new receiver set. Once a response to the packet has been received from all the receivers, the new multicast forwarding state can be created and the associated multicast flow can then be switched to the new receiver set.

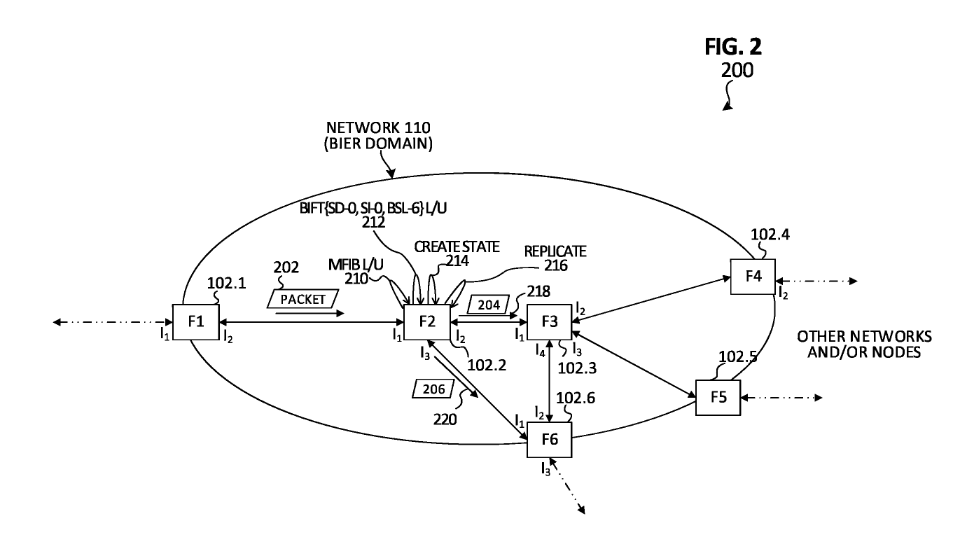

Referring to FIG. 2, FIG. 2 is a simplified block diagram 200 illustrating example operations and interactions that can be performed to facilitate packet forwarding by a stateful BIER enabled forwarder in accordance with one potential embodiment. FIG. 2 includes network that includes stateful BIER enabled forwarders F1-F6 102.1-102.6. For the embodiment of FIG. 2, it is assumed that stateless BIER-capable forwarder F7 104 is not implemented in the network and that each of stateful BIER enabled forwarder F4 102.4, stateful BIER enabled forwarder F5 102.5, and stateful BIER enabled forwarder F6 have expressed an interest in receiving a multicast flow associated with a packet 202 received by forwarder F2 102.2 within a BIER sub-domain 0 (SD-0) in which the set of receivers is identified by a Set Identifier 0 (SI-0) for a 6-bit BSL (BSL-6). Note, the 6-bit BSL is provided for illustrative purposes only and is not meant to limit the broad scope of the present disclosure. Further for the embodiment of FIG. 2, it is assumed that forwarder F2 102.2 is provisioned with output interface information that identifies first interface I₁ associated with neighbor F1 102.1, that identifies second interface I₂ associated with neighbor F3 102.3, and that identifies third interface I₃ associated with neighbor F6 102.6. It should be understood that other BIFTs can be provisioned for forwarder F2 102.2 for other combinations of receiver sets for other sub-domains, set identifiers and BitString lengths.

For the embodiment of FIG. 2, stateful BIER enabled forwarder F2 102.2 can be provisioned with an BIFT associated with a BIER SD-0, SI-0, BSL-6, which can be represented as ‘BIFT{SD-0, SI-0, BSL-6}’ and is shown below in TABLE 1.

TABLE 1
EXAMPLE BIFT{SD-0, SI-0, BSL-6} FOR STATEFUL
BIER ENABLED FORWARDER F2

| BFR-ID/ADDR. | BitMask | NEIGHBOR |
|---|---|---|
| 4 (001000) | 011000 | F3 |
| 5 (010000) | 011000 | F3 |
| 6 (100000) | 100000 | F6 |

The example BIFT shown in TABLE 1 identifies neighboring forwarders to which packets are to be forwarded in order to reach certain destination forwarders (e.g., F1, F4, F5, and/or F6, depending on multicast flow direction). The example BIFT shown in TABLE 1 can be provisioned for stateful BIER enabled forwarder F2 using techniques as defined in IETF ‘Multicast using Bit Index Explicit Replication’, draft-ietf-bier-architecture-05, published Oct. 16, 2016 or the like as may be defined by the IETF.

As shown in TABLE 1, for packets that are to be forwarded to forwarder F4 102.4 and F5 102.5, forwarder F2 102.2 is to include a BIER BitString using BitMask=[011000]. For packets that are to be forwarded to forwarder F6 102.6, forwarder F2 102.2 is to include a BIER BitString using BitMask=[100000] for outgoing packets. Because F6 is the shortest distance next-hop neighbor to reach F6, it is identified as the neighbor for packet forwarding.

For the embodiment of FIG. 2, assume that stateful BIER enabled forwarder F2 102.2 receives BIER packet 202 that includes a BIER prefix identifying SD-0, SI-0, and BSL-6 and a BIER BitString set to [111000], and that the forwarder has no multicast forwarding state created for the BitString stored in its MFIB. At 210, the forwarder performs a lookup (L/U) on its MFIB and determines that no multicast forwarding state has been created for the receiver group. Based on the determination at 210 that no multicast forwarding state exists for the receiver group, the forwarder punts the packet to the BIER control plant to perform a lookup (212) on BIFT{SD-0, SI-0, BSL-6} as shown in TABLE 1 using the BIER BitString to identify neighbors F3 and F6 to which the packet is to be forwarded in order to reach destination forwarders F4, F5, and F6 for SD-0, SI-0, and BSL-6.

Based on the BIFT lookup performed at 212, the forwarder generates an O-List including F3 and F6 and creates (214) a multicast forwarding state in its MFIB, as shown below in TABLE 2.

TABLE 1
EXAMPLE MFIB FOR STATEFUL BIER ENABLED FORWARDER F2

| GROUP | O-List | BIER Address |
|---|---|---|
| 111000 | F3 | 0x18 |
| | F6 | 0x20 |
| . . . | | |

The multicast forwarding state can be associated with a multicast receiver group identified by BIER BitString=[111000], having an O-List={F3 and F6} in which BIER address information for F3 identifies a BIER address of hexadecimal ‘0x18’ for a BIER BitString=[011000] and BIER address information for F6 identifies a BIER address of hexadecimal ‘0x20’ for a BIER BitString=[100000] for the MFIB as shown in TABLE 2. It should be understood that other multicast forwarding states can be created for the MFIB during operation. In various embodiments, output BIER address information stored in an MFIB can be configured in any format that can be used to identify a BIER BitString for outgoing packets. The hexadecimal values shown for the embodiment of FIG. 2 are provided for illustrative purposes only and are not meant to limit the broad scope of the teachings of the present disclosure.

Based on the multicast forwarding state created for the receiver group at 214, the forwarder can determine that the packet is to be forwarded along diverging paths and can replicate (216) the packet for each path to generate a packet 204 to be forwarded to F3 and a packet 206 to be forwarded to F6. For packet 204 to be forwarded to F3, the forwarder F2 can update the BIER BitString in the packet using the updated BIER address 0x18 and can forward the packet 204 to forwarder F3 at 218. For packet 206 to be forwarded to F6, the forwarder F2 can update the BIER BitString using the updated BIER address 0x20 and can forward the packet 206 to forwarder F6 at 220.

For any subsequent packets received for any multicast flow associated with the receiver group including forwarder F4, F5, and F6, the packets can be replicated, have their BIER BitStrings updated, and forwarded to neighbors F3 and F6. Similar forwarding operations can be performed by F3. Forwarders F4, F5 and F6 can forward packets outside the BIER domain using traditional forwarding techniques. Thus, the system and method provided by communication system 100 enables stateful BIER operations to be performed to forward and replicate, when needed, multicast packets through a network without a Tree building protocol. In various embodiments, the system and method can provide benefits to native BIER forwarding operations in the sense that a packet can follow unicast routing through a network to reach multiple destinations.

In at least one embodiment, BIER-like forwarding can be supported on hardware that is not able to perform native BIER forwarding operations, which can provide an implementable migration path for network designers that desire to deploy BIER architectures for networks in which the hardware may be limited to non-BIER forwarding engines that cannot be configured to support native BIER. For such deployments, native BIER Nodes can be interconnected with non-BIER nodes that can perform stateful BIER procedures to realize a BIER deployment.

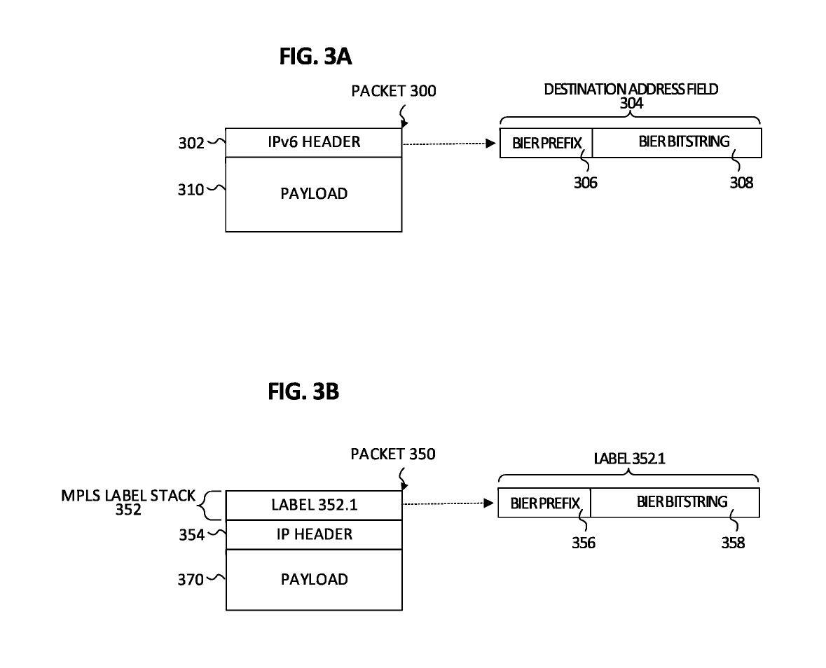

Referring to FIGS. 3A-3B, FIGS. 3A-3B are simplified schematic diagrams illustrating example details that can be associated with example packets that can support stateful BIER forwarding in accordance with at least one embodiment.

Referring to FIG. 3A, FIG. 3A is a simplified schematic diagram illustrating example details that can be associated with an example packet 300 that can support stateful BIER enabled forwarding in accordance with at least one embodiment. In particular, example packet 300 can represent an IPv6 encapsulated packet. Packet 300 can include an IPv6 header 302 and a payload 310. IPv6 header 302 can include, among other IPv6 header fields, a 128-bit destination address field 304 that can be enhanced to carry a BIER prefix 306 and a BIER BitString 308 (e.g., a BIER address). In various embodiments, the BIER prefix 306 can range in length from 28-64 bits and the BIER BitString 308 can range in length from 64-100 bits.

Referring to FIG. 3B, FIG. 3B is a simplified schematic diagram illustrating example details that can be associated with an example packet 350 that can support stateful BIER enabled forwarding in accordance with at least one embodiment. In particular, example packet 350 can represent an MPLS encapsulated packet. Packet 350 can include an MPLS label stack 352 comprising a single label 352.1, an IP header 354, and a payload 370. Label 352.1 can be enhanced to carry a BIER prefix 356 and a BIER BitString 358 (e.g., a BIER address). In various embodiments, an MPLS label can vary in length up to 256 bits; thus, BIER prefix 356 and BIER BitString 358 can be varied in length depending on the length of an MPLS label.

Accordingly, as shown for the embodiments of FIGS. 3A-3B, packet headers and labels can be enhanced to carry BIER information such as a BIER prefix and a BIER BitString (e.g., a BIER address). The example packet formats described for the embodiments of FIGS. 3A-3B are only a few of the many formats that can be used to carry BIER information in packets in accordance with the teachings of the present disclosure. Virtually any other means can be used to carry BIER information in packets using similar means and methods as those described herein and, thus, are clearly within the scope of the teachings of the present disclosure.

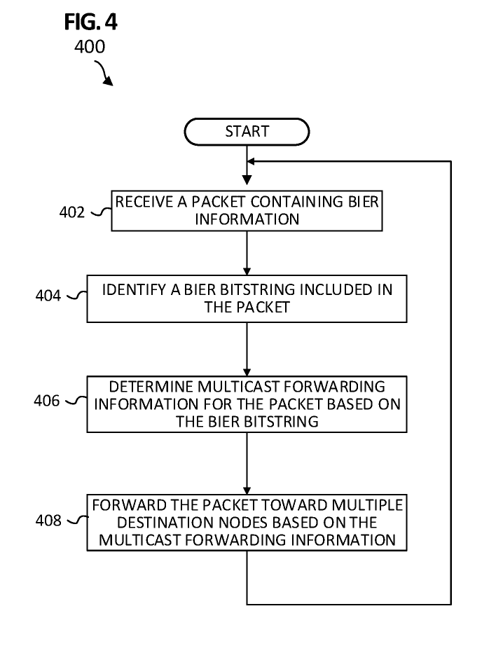

Referring to FIG. 4, FIG. 4 is a simplified flow diagram illustrating example operations 400 that can be associated with stateful BIER packet forwarding in accordance with at least one embodiment. In at least one embodiment, example operations 400 can be performed by a node within a given BIER domain of a network (e.g. any of stateful BIER enabled forwarders F1-F6 102.1-102.6 within network 110).

At 402, the operations can include the node receiving a packet containing BIER information. At 404, the operations can include the node identifying a BIER BitString included in the BIER information for the packet. At 406, the operations can include the node determining multicast forwarding information for the packet based on the BIER BitString included with the packet. In various embodiments, the operations at 406 can include determining the multicast forwarding information for an existing multicast forwarding state associated with the BIER BitString that has already been created for the node or for a newly created multicast forwarding state that can be created for the node based on the BIER BitString upon receiving the packet and determining that no multicast forwarding state currently exists at the node.

At 408, the operations can include forwarding the packet towards multiple destination nodes based on the multicast forwarding information and the operations can return to 402 to receive another packet and the operations can be repeated. In various embodiments, the operations at 408 can include replicating the packet if it is to be forwarded along diverging paths and updating the BIER BitString for the (potentially replicated) packet(s) prior to the forwarding.

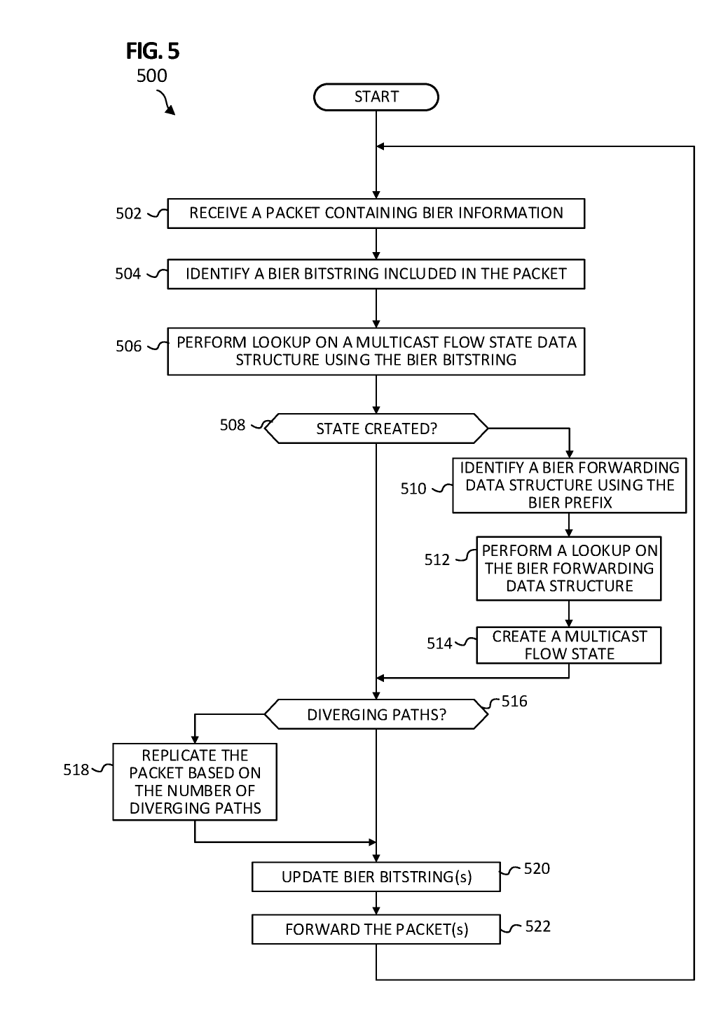

Referring to FIG. 5, FIG. 5 is a simplified flow diagram illustrating other example operations 500 that can be associated with stateful BIER packet forwarding in accordance with at least one embodiment. In at least one embodiment, example operations 400 can be performed by a node within a given BIER domain of a network (e.g. any of stateful BIER enabled forwarders F1-F6 102.1-102.6 within network 110).

At 502, the operations can include the node receiving a packet containing BIER information. At 504, the operations can include the node identifying a BIER BitString included in the BIER information for the packet. At 506, the operations can include the node performing a lookup on a multicast forwarding state data structure (e.g., an MFIB) provisioned for the node using the BIER BitString. At 508, the operations can include the node determining whether a multicast forwarding state has been created for the group of destination nodes identified in the BIER BitString based on the lookup on the multicast forwarding state data structure.

Based on a determination at 508 that no multicast forwarding state has been created within the data structure for the BIER BitString, the operations can continue to 510 at which the node identifies a BIER forwarding data structure (e.g., a BIFT) using the BIER prefix included with the packet (e.g., the BIER prefix can identify the data structure based on the combination of SD, SI, and BSL identified in the BIER prefix) and the operation can continue to 512. At 512, the node performs a lookup on the BIER forwarding data structure to identify one or more neighboring forwarders to which the packet is to be forwarded in order to reach the group of destination nodes and to determine a BIER BitMask (e.g., a forwarding ‘address’) associated with each identified neighboring forwarder and the operations can continue to 514. At 514, the node creates a multicast forwarding state in the multicast forwarding state data structure (e.g., an MFIB) that identifies multicast forwarding information for the group of destination nodes. The multicast forwarding information can identify the BIER BitString associated with the group of destination nodes, an O-List for neighboring node(s) to which the packet is to be forwarded, and BIER address information associated with each neighboring node(s) identifying a BIER BitString that is to be included with each packet forwarded to each neighboring node and the operations can continue to 516.

Based on a determination at 508 that a multicast forwarding state has been created within the multicast forwarding state data structure for the BIER BitString included within the received packet or after 514, the operations can continue to 516. At 516, the operations can include the node determining whether the packet is to be forwarded along diverging paths in order to be delivered to the group of destination nodes. In at least one embodiment, the determination at 516 can include determining that output information for more than one next-hop neighbor is identified in an O-list for a particular group of destination nodes to which a packet is to be forwarded. Based on a determination at 516, that the packet is to be forwarded along diverging paths, the operations can continue to 518 at which the node replicates the packet based on the number of diverging paths to generate a corresponding number of replicated packets and the operations can continue to 520.

Based on a determination at 516 that the packet is not to be forwarded along diverging paths, the operations can continue to 520. At 520, the operations can include the node updating the BIER BitString (e.g., the BIER address(es)) for the outgoing packet(s) based on the BIER address information associated with each neighboring node(s) and the operations can continue to 522. At 522, the operations can include the node forwarding the outgoing packet(s) to each neighboring node(s) and the operations can return to 502 to receive another packet and the operations can be repeated

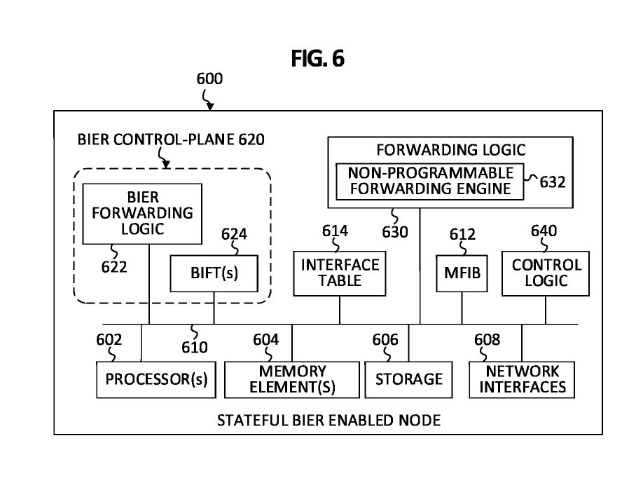

Referring to FIG. 6, FIG. 6 is a simplified block diagram illustrating example details that can be associated with an example stateful BIER enabled node 600 that can be configured to operate in communication system 100 in accordance with at least one embodiment. Example stateful BIER enabled node 600 can be representative of any of stateful BIER enabled forwarders F1-F6 102.1-102.6 or any other stateful BIER enabled forwarder that may be deployed in network 110. In at least one embodiment, stateful BIER enabled node 600 can include one or more processor(s) 602, one or more memory element(s) 604, storage 606, network interfaces 608, a bus 610, BIER forwarding logic 622, one or more BIFT(s) 624, an MFIB 612, an interface table 614, forwarding logic 630 including a non-programmable forwarding engine 632, and control logic 640. In at least one embodiment, BIER forwarding logic 622 and BIFT(s) 624 can represent logical BIER control-plane functionality 620 for the stateful BIER enabled node 600. In various embodiments, instructions associated with any logic, engines, etc. provisioned for stateful BIER enabled node 600 can overlap in any manner and are not limited to the specific allocation of instructions and/or operations described herein.

In at least one embodiment, processor(s) 602 is/are at least one hardware processor configured to execute various tasks, operations and/or functions for stateful BIER enabled node 600 as discussed for various embodiments described herein according to software and/or instructions configured for stateful BIER enabled node 600. In at least one embodiment, memory element(s) 604 and/or storage 606 is/are configured to store data, information, software, and/or instructions associated with stateful BIER enabled node 600, and/or logic configured for memory element(s) 604 and/or storage 606 (e.g., any logic, engines, etc. can, in various embodiments, be stored using any combination of memory element(s) 604 and/or storage 606). Note that in some embodiments, storage can be consolidated with memory elements (or vice versa), or can overlap/exist in any other suitable manner.

In at least one embodiment, bus 610 can be configured as an interface that enables one or more elements of stateful BIER enabled node 600 to communicate in order to exchange information and/or data. In at least one embodiment, bus 610 may be implemented as a fast kernel-hosted interconnect, potentially using shared memory between processes (e.g., logic, etc.), which can enable efficient communication paths between the processes.

In various embodiments, network interfaces 608 enable communication between stateful BIER enabled node 600, and other network elements, systems, etc. that may be present in communication system 100 to facilitate operations discussed for various embodiments described herein. In some embodiments, network interfaces 608 can include one or more Ethernet driver(s) and/or controller(s), Fibre Channel driver(s) and/or controller(s), or other similar network interface driver(s) and/or controller(s) to enable communications for stateful BIER enabled node 600 within communication system 100.

Various data structures can be provisioned for stateful BIER enabled node 600 including, but not limited to, one or more BIFT(s) 624, MFIB 612, and interface table 614. In at least one embodiment, each of the one or more BIFT(s) 624 can be associated with and identified by a particular combination of SD, SI, and BSL for a given set of destination nodes belonging to the SD and the SI for the given BSL. Each of the one or more BIFT(s) 624 can be provisioned, automatically or manually, with a BitMask and a neighbor identifier for each of one or more next hop neighbors that packet(s) are to be forwarded to in order to reach one or more destination node(s) for a shortest path between node 600 and each destination node(s). In at least one embodiment, interface table 614 can be provisioned, automatically or manually, with a neighbor identifier for each next-hop neighbor to which node 600 may be connected and an interface identifier that identifies which interface to use for exchanging communications with each next hop neighbor. The interface table can be used to populate the O-List for MFIB 612.

In at least one embodiment, MFIB 612 can include multicast forwarding information for each of one or more set(s) or group(s) of destination nodes toward which packets can be forwarded for one or more multicast flows that may be handled by the node 600. In at least one embodiment, multicast forwarding information can include, for a given entry associated with a particular set of destination nodes, a BIER BitString identifying the particular set of destination nodes, an O-List identifying one or more next-hop neighbors to which packets are to be forwarded to reach each of the destination nodes, and BIER address information (e.g., a BIER BitString) that is to be included with each packet forwarded to each next-hop neighbor identified in the O-List.

In various embodiments, forwarding logic 630 can include instructions that, when executed (e.g., by one or more processor(s) 602), cause stateful BIER enabled node 600 to perform operations, which can include, but not be limited to: receiving packets; parsing BIER information from received packets; performing lookups on MFIB 612 to determine multicast forwarding information based on BIER information included in received packets; punting packets to the BIER-control plane 620 based on determinations that no multicast forwarding state is present for a particular set of destination nodes identified in a BitString for a given received packet; generating O-List information and BIER address information for a given set of destination nodes (e.g., if not performed by BIER forwarding logic 622); creating a multicast forwarding state within MFIB 612 for a given set of destination nodes based on multicast forwarding information received from other logic (e.g., if BIER forwarding logic 622 is not responsible for creating state within MFIB 612); performing, via instructions included in non-programmable forwarding engine 632, packet replication, if needed, and packet forwarding; updating BIER BitStrings for forwarded packets; cooperating, maintaining, and/or otherwise interacting with logic; data structures; stored data, information, parameters, etc. (e.g., memory element(s), storage, data structures, databases, tables, etc.) of stateful BIER enabled node 600; combinations thereof; and/or the like to facilitate various operations as discussed for various embodiments described herein.

In various embodiments, BIER forwarding logic 622 can include instruction that, when executed (e.g., by one or more processor(s) 602), cause stateful BIER enabled node 600 to perform operations, which can include, but not be limited to: identifying a particular BIFT for a given combination SD, SI, and BSL included in a BIER prefix for a packet; performing a lookup one a particular BIFT identified for a given combination of SD, SI, and BSL using a BIER BitString included in a packet; identifying multicast forwarding information (e.g., BIER BitMasks and next-hop neighbors) for a given set of destination nodes identified in a BIER BitString; generating O-List information and BIER address information for a given set of destination nodes (e.g., if not performed by forwarding logic 630); sending multicast forwarding information identified from a BIFT lookup to forwarding logic 630 for creating a multicast forwarding state within MFIB 612 for a set of destination nodes (e.g., if forwarding logic 630 is not responsible for creating state); sending punted packets back to forwarding logic 630 following determination of multicast forwarding information for a given set of destination nodes; cooperating, maintaining, and/or otherwise interacting with logic; data structures; stored data, information, parameters, etc. (e.g., memory element(s), storage, data structures, databases, tables, etc.) of stateful BIER enabled node 600; combinations thereof; and/or the like to facilitate various operations as discussed for various embodiments described herein.

In various embodiments, control logic 640 can include instructions that, when executed (e.g., by one or more processor(s) 602), cause stateful BIER enabled node 600 to perform operations, which can include, but not be limited to: providing overall control operations of stateful BIER enabled node 600; cooperating, maintaining, and/or otherwise interacting with logic, data structures, stored data, information, parameters, etc. (e.g., memory element(s), storage, data structures, databases, tables, etc.) of stateful BIER enabled node 600 to perform various operations; combinations thereof; and/or the like to facilitate various operations as discussed for various embodiments described herein.

### VARIATIONS AND IMPLEMENTATIONS

Communications in a network environment can be referred to as ‘messages’, ‘messaging’, ‘signaling’, and/or variations thereof which may be inclusive of packets. As discussed herein in this Specification, a packet is a formatted unit of information that can contain control information (e.g., source and destination address, etc.) with or without data, which is also known as payload. In some embodiments, control information can be included in headers and trailers for packets or frames. Packets can be sent and received according to any suitable communication protocols. Suitable communication protocols can include a multi-layered scheme such as the Open Systems Interconnection (OSI) Model, or any derivations or variants thereof. The terms ‘data’, ‘information’, and ‘parameters’ as used herein can refer to any type of binary, numeric, voice, video, textual or script data or information, or any type of source or object code, or any other suitable data or information in any appropriate format that can be communicated from one point to another in electronic devices and/or networks. Additionally, signaling, messages, requests, responses, replies, queries, etc. are forms of network traffic and, therefore, may comprise one or more packets.

In various embodiments, communication system 100 may implement user datagram protocol/Internet Protocol (UDP/IP) connections and/or transmission control protocol/IP (TCP/IP) communication language protocol in particular embodiments of the present disclosure. However, communication system 100 can alternatively implement any other suitable communication protocol, interface and/or standard, proprietary and/or non-proprietary, for transmitting and receiving messaging and/or signaling. Other protocols, interfaces, and/or communication standards that can be used in communication system 100 can include a Terminal Access controller access-control system (TACACS), TACACS+, Proxy Mobile IPv6 (PMIPv6), PMIPv4, Extensible Messaging and Presence Protocol (XMPP), General Packet Radio Service (GPRS) Tunneling Protocol (GTP) (version 1 or version 2), Generic Route Encapsulation (GRE), Ethernet over GRE (EoGRE), Extensible Messaging and Presence Protocol (XMPP), Simple Object Access Protocol (SOAP), SOAP over Hypertext Transfer Protocol (HTTP), Representational State Transfer (REST), combinations thereof, or the like. In some embodiments, secure communications can be facilitated using TCP/IP Secure Sockets Layer (SSL) communications.

Communication system 100 can include one or more networks, such network 110, which can represent a series of points or nodes of interconnected communication paths for receiving and transmitting messages (e.g., packets of information) that propagate through the one or more networks. These nodes offer communicative interfaces that facilitate communications between the nodes. A network can comprise any number of hardware and/or software elements coupled to (and in communication with) each other through a communication medium. Such networks can include, but are not limited to, any local area network (LAN), virtual local area network (VLAN), wide area network (WAN) such as the Internet, wireless local area network (WLAN), metropolitan area network (MAN), Intranet, Extranet, virtual private network (VPN), Low Power Network (LPN), Low Power Wide Area Network (LPWAN), Machine to Machine (M2M) network, IoT network, any other appropriate architecture or system that facilitates communications in a network environment, combinations thereof, or any suitable combination thereof.

Networks through which communications propagate in communication system 100 can use any suitable technologies for communication including wireless (e.g., 3G/4G/5G/nG, IEEE 802.11 (e.g., Wi-Fi), IEEE 802.16 (e.g., Worldwide Interoperability for Microwave Access (WiMAX)), Radio-frequency Identification (RFID), Near Field Communication (NFC), Bluetooth™, mm.wave, etc.), and/or wired (e.g., T1 lines, T3 lines, digital subscriber lines (DSL), Ethernet, Fibre Channel, etc.) communication. Generally, any suitable means of communication may be used such as electric, sound, light, infrared, and/or radio.

In regards to the internal structure associated with communication system 100, appropriate software, hardware, and/or algorithms are being provisioned for stateful BIER enabled nodes (e.g., stateful BIER enabled forwarders F1-F6 102.1-102.6 and stateful BIER enabled node 600) within communication system 100 in order to facilitate stateful BIER forwarding operations in a network environment in accordance with the teachings of the present disclosure.

In various example implementations, stateful BIER enabled nodes (e.g., stateful BIER enabled forwarders F1-F6 102.1-102.6 and stateful BIER enabled node 600) discussed for various embodiments described herein can encompass network elements such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various stateful BIER forwarding operations in a network environment (e.g., for networks such as those illustrated in FIGS. 1-2) as described for various embodiments discussed herein. In various embodiments, stateful BIER enabled nodes (e.g., stateful BIER enabled forwarders F1-F6 102.1-102.6 and stateful BIER enabled node 600) can include software (or reciprocating software) that can coordinate in order to achieve operations associated with providing stateful BIER forwarding in a network environment as discussed herein and may include any suitable algorithms, hardware, software, components, modules, logic, clients, interfaces, and/or objects that facilitate the operations thereof. This may be inclusive of appropriate algorithms, communication protocols, interfaces, and/or standards, proprietary and/or non-proprietary, that allow for the effective exchange of data or information.

In various embodiments, stateful BIER enabled nodes (e.g., stateful BIER enabled forwarders F1-F6 102.1-102.6 and stateful BIER enabled node 600) as discussed herein may keep information in any suitable memory element [e.g., random access memory (RAM), read only memory (ROM), an erasable programmable read only memory (EPROM), application specific integrated circuit (ASIC), etc.], software, hardware, or in any other suitable component, device, element, and/or object where appropriate and based on particular needs. Any of the memory items discussed herein should be construed as being encompassed within the broad term ‘memory element’. Information being tracked or sent to stateful BIER enabled nodes (e.g., stateful BIER enabled forwarders F1-F6 102.1-102.6 and stateful BIER enabled node 600) discussed herein could be provided in any database, table, register, control list, cache, storage and/or storage structure: all of which can be referenced at any suitable timeframe. Any such storage options may also be included within the broad term ‘memory element’ as used herein. Any of potential processing elements, controllers, systems, managers, logic, and/or machines described herein can be construed as being encompassed within the broad term ‘processor’. In various embodiments, stateful BIER enabled nodes (e.g., stateful BIER enabled forwarders F1-F6 102.1-102.6 and stateful BIER enabled node 600) discussed herein can also include suitable interfaces for receiving, transmitting, and/or otherwise communicating data or information in a network environment.

Note that in certain example implementations, operations as outlined herein to facilitate stateful BIER forwarding in a network environment may be implemented by logic encoded in one or more tangible media, which may be inclusive of non-transitory tangible media and/or non-transitory computer readable storage media (e.g., embedded logic provided in an ASIC, in digital signal processing (DSP) instructions, software [potentially inclusive of object code and source code] to be executed by a processor, or other similar machine, etc.). In some of these instances, a memory element and/or storage can store data, software, code, instructions (e.g., processor instructions), logic, parameters, combinations thereof, or the like used for operations described herein. This includes memory elements and/or storage being able to store data, software, code, instructions (e.g., processor instructions), logic, parameters, combinations thereof, or the like that are executed to carry out operations in accordance with teachings of the present disclosure.

A processor (e.g., a hardware processor) can execute any type of instructions associated with data to achieve the operations detailed herein. In one example, a processor can transform an element or an article (e.g., data, information) from one state or thing to another state or thing. In another example, operations outlined herein may be implemented with logic, which can include fixed logic, hardware logic, programmable logic, digital logic, etc. (e.g., software/computer instructions executed by a processor) and/or one or more the elements described herein could be some type of a programmable processor, programmable digital logic (e.g., a field programmable gate array (FPGA), a DSP processor, an EPROM, a controller, an electrically erasable PROM (EEPROM), or an ASIC) that includes digital logic, software, code, electronic instructions, or any suitable combination thereof.

One or more advantages mentioned herein do not in any way suggest that any one of the embodiments described herein necessarily provides all the described advantages or that all the embodiments of the present disclosure necessarily provide any one of the described advantages. Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also important to note that the operations and steps described with reference to the preceding FIGURES illustrate only some of the possible scenarios that may be executed by, or within, the communication system 100. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Note that with the examples provided above, as well as numerous other examples provided herein, interaction may be described in terms of one, two, three, or four network elements. However, this has been done for purposes of clarity and example only. In certain cases, it may be easier to describe one or more of the functionalities by only referencing a limited number of network elements. It should be appreciated that communication system 100 (and its teachings) are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

As used herein, unless expressly stated to the contrary, use of the phrase ‘at least one of’, ‘one or more of’ and ‘and/or’ are open ended expressions that are both conjunctive and disjunctive in operation for any combination of named elements, conditions, or activities. For example, each of the expressions ‘at least one of X, Y and Z’, ‘at least one of X, Y or Z’, ‘one or more of X, Y and Z’, ‘one or more of X, Y or Z’ and ‘A, B and/or C’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms ‘first’, ‘second’, ‘third’, etc., are intended to distinguish the particular nouns (e.g., element, condition, module, activity, operation, etc.) they modify. Unless expressly stated to the contrary, the use of these terms is not intended to indicate any type of order, rank, importance, temporal sequence, or hierarchy of the modified noun. For example, ‘first X’ and ‘second X’ are intended to designate two X elements that are not necessarily limited by any order, rank, importance, temporal sequence, or hierarchy of the two elements. As referred to herein, ‘at least one of’, ‘one or more of’, and the like can be represented using the ‘(s)’ nomenclature (e.g., one or more element(s)).

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access, interfaces, and protocols, communication system 100 may be applicable to other exchanges or routing protocols, interfaces, and/or communications standards, proprietary and/or non-proprietary. Moreover, although communication system 100 has been illustrated with reference to particular elements and operations that facilitate the communication process, these elements, and operations may be replaced by any suitable architecture or process that achieves the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method comprising:
receiving a packet at a node, wherein the node comprises one or more first data structures comprising Bit Index Explicit Replication (BIER) BitMask information for one or more neighboring forwarders and a second data structure comprising multicast forwarding information;
identifying a BIER BitString contained in the packet, wherein the BIER BitString is identified within an Internet Protocol (IP) header or a label included with the packet;
determining multicast forwarding information for the packet based on the BIER BitString; and
forwarding the packet toward a plurality of destination nodes based on the multicast forwarding information.

2. The method of claim 1, wherein the BIER BitMask information for each of the one or first data structures identifies a respective BitMask for each of a respective next-hop neighbor node for a particular BIER subdomain and a particular Set Identifier.

3. The method of claim 1, wherein the multicast forwarding information for the second data structure identifies one or more BIER BitStrings and, for each of a particular BIER BitString, the second data structure further identifies one or more output interfaces associated with the particular BIER BitString upon which received packets are to be forwarded and a BIER BitString that is to be included with each packet forwarded across the output interfaces.

4. The method of claim 1, wherein the forwarding further comprises:
updating the IP header or the label included with the packet.

5. The method of claim 4, wherein the updating further comprises one of:
removing the IP header or the label included with the packet and including a new IP header or a new label with the packet, wherein the new IP header or the new label includes a new BIER BitString; or
overwriting the IP header or the label to include a new BIER BitString.

6. The method of claim 1, further comprising:
replicating the packet based on a determination that the multicast forwarding information identifies diverging forwarding paths for the packet;
updating the IP header or the label included with each replicated packet based on the multicast forwarding information; and
forwarding each replicated packet to a next-hop neighbor node as identified in the multicast forwarding information.

7. The method of claim 1, wherein the determining and the forwarding further comprise:
determining whether the BIER BitString is identified in the second data structure; and
forwarding the packet based on the multicast forwarding information contained in the second data structure based on a determination that the BIER BitString is identified in the second data structure.

8. The method of claim 7, further comprising:
identifying BIER BitMask information associated with the BIER BitString using a particular first data structure based on a determination that the BIER BitString is not identified in the second data structure; and
updating the second data structure with the multicast forwarding information based on the BIER BitMask information identified in the particular first data structure.

9. One or more non-transitory tangible media encoding logic that includes instructions for execution by a processor, wherein the execution causes the processor to perform operations comprising:
receiving a packet at a node, wherein the node comprises one or more first data structures comprising Bit Index Explicit Replication (BIER) BitMask information for one or more neighboring forwarders and a second data structure comprising multicast forwarding information;
identifying a BIER BitString contained in the packet, wherein the BIER BitString is identified within an Internet Protocol (IP) header or a label included with the packet;
determining multicast forwarding information for the packet based on the BIER BitString; and
forwarding the packet toward a plurality of destination nodes based on the multicast forwarding information.

10. The media of claim 9, wherein the BIER BitMask information for each of the one or first data structures identifies a respective BitMask for each of a respective next-hop neighbor node for a particular BIER subdomain and a particular Set Identifier.

11. The media of claim 9, wherein the multicast forwarding information for the second data structure identifies one or more BIER BitStrings and, for each of a particular BIER BitString, the second data structure further identifies one or more output interfaces associated with the particular BIER BitString upon which received packets are to be forwarded and a BIER BitString that is to be included with each packet forwarded across the output interfaces.

12. The media of claim 9, wherein the forwarding further comprises:
updating the IP header or the label included with the packet.

13. The media of claim 12, wherein the updating further comprises one of:
removing the IP header or the label included with the packet and including a new IP header or a new label with the packet, wherein the new IP header or the new label includes a new BIER BitString; or
overwriting the IP header or the label to include a new BIER BitString.

14. The media of claim 9, wherein the execution causes the processor to perform further operations, comprising:
replicating the packet based on a determination that the multicast forwarding information identifies diverging forwarding paths for the packet;
updating the IP header or the label included with each replicated packet based on the multicast forwarding information; and
forwarding each replicated packet to a next-hop neighbor node as identified in the multicast forwarding information.

15. The media of claim 9, wherein the determining and the forwarding further comprise:
determining whether the BIER BitString is identified in the second data structure; and
forwarding the packet based on the multicast forwarding information contained in the second data structure based on a determination that the BIER BitString is identified in the second data structure.

16. The media of claim 15, wherein the execution causes the processor to perform operations, comprising:
identifying BIER BitMask information associated with the BIER BitString using a particular first data structure based on a determination that the BIER BitString is not identified in the second data structure; and
updating the second data structure with the multicast forwarding information based on the BIER BitMask information identified in the particular first data structure.

17. A node comprising:
at least one memory element for storing data; and
at least one processor for executing instructions associated with the data, wherein the executing causes the node to perform operations comprising:
receiving a packet at the node, wherein the node further comprises one or more first data structures comprising Bit Index Explicit Replication (BIER) BitMask information for one or more neighboring forwarders and a second data structure comprising multicast forwarding information;
identifying a BIER BitString contained in the packet, wherein the BIER BitString is identified within an Internet Protocol (IP) header or a label included with the packet;
determining multicast forwarding information for the packet based on the BIER BitString; and
forwarding the packet toward a plurality of destination nodes based on the multicast forwarding information.

18. The node of claim 17, wherein the BIER BitMask information for each of the one or first data structures identifies a respective BitMask for each of a respective next-hop neighbor node for a particular BIER subdomain and a particular Set Identifier.

19. The node of claim 17, wherein the multicast forwarding information for the second data structure identifies one or more BIER BitStrings and, for each of a particular BIER BitString, the second data structure further identifies one or more output interfaces associated with the particular BIER BitString upon which received packets are to be forwarded and a BIER BitString that is to be included with each packet forwarded across the output interfaces.

20. The node of claim 17, wherein the executing causes the node to perform further operations, comprising:
replicating the packet based on a determination that the multicast forwarding information identifies diverging forwarding paths for the packet;
updating the IP header or the label included with each replicated packet based on the multicast forwarding information; and
forwarding each replicated packet to a next-hop neighbor node as identified in the multicast forwarding information.
